(19) United States
(12) Patent Application Publication
(10) Pub. No.: US 2009/0008823 A1
(43) Pub. Date: Jan. 8, 2009

(54) Sealed Sensor Assembly and Method of Making the Same

(75) Inventors: Tim Alexander, Sarasota, FL (US); Scott D. Hall, Sullivan, FL (US); Jon Bossoli, Venice, FL (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE, INC., Warren, OH (US)

(21) Appl. No.: 11/846,779

(22) Filed: Aug. 29, 2007

Related U.S. Application Data
(60) Provisional application No. 60/823,845, filed on Aug. 29, 2006.

(51) Int. Cl. B29C 45/14

(52) U.S. Cl. 264/279.1

(57) ABSTRACT

A method of sealing a sensor assembly from contaminants including inserting the assembly into an overmold, providing a first stage overmold to cover a first portion of said sensor assembly intended to be external to an associated bore, and providing a second stage overmold to cover a second portion of the assembly intended to be disposed in the associated bore.

### CROSS-REFERENCE TO RELATED APPLICATIONS

This application claims the benefit of the filing date of U.S. Provisional Patent Application Ser. No. 60/823,845 entitled “SEALED SENSOR ASSEMBLY AND METHOD OF MAKING THE SAME”, filed Aug. 29, 2006, the teachings of which are fully incorporated herein by reference.

### TECHNICAL FIELD

The present disclosure relates to sealing of an electrical assembly and more particularly, to a system and method for sealing a sensor assembly thorough over molding.

### BACKGROUND INFORMATION

A sensor assembly, such as a speed sensor assembly, may conventionally include a separate o-ring to seal the interface between the sensor and an associated bore into which a portion of the sensor is installed. In addition, a separate covering or can may be provided over the sensor to seal the sensor from contamination.

### BRIEF DESCRIPTION OF THE DRAWINGS

Details of the present disclosure will be better understood by reading the following detailed description, taken together with the drawings wherein:

FIG. 1 is a perspective view of one exemplary embodiment of a speed sensor carrier assembly portion of a sealed sensor assembly consistent with the present disclosure;

FIG. 2 is an exploded view of the carrier assembly illustrated in FIG. 1;

FIGS. 3A and 3B are perspective and side views, respectively, illustrating loading of the carrier assembly of FIG. 1 and a bushing into an overmold consistent with the present disclosure;

FIGS. 4A and 4B are perspective and side views, respectively, illustrating a first stage overmold consistent with the present disclosure applied to the cabled carrier assembly and bushing shown in FIGS. 3A and 3B;

FIGS. 5A-5D are perspective, front, side and top views, respectively, illustrating a second stage overmold consistent with the present disclosure applied to the overmolded cabled carrier assembly and bushing shown in FIGS. 4A and 4B;

FIG. 6 is perspective view of one exemplary embodiment of a sealed sensor assembly consistent with the present disclosure; and

FIG. 7 is a perspective view of a cable assembly incorporating a sealed sensor assembly consistent with the present disclosure.

### DETAILED DESCRIPTION

The present disclosure is generally directed to a sealing of a sensor assembly through overmolding. In general, a sealed sensor assembly and method consistent with the disclosure may provide an integral seal for sealing a sensor, such as a vehicle speed sensor, to an associated bore and/or an enclosure for sealing the sensor from contaminants using one or more elastomeric overmolds. In one exemplary embodiment, a sensing end of the sensor may be overmolded with an elastomeric compound. The elastomeric overmold may adhere to a plastic sensor housing and seal the sensor from external elements/contaminants. For applications requiring that the sensor be sealed against intrusion into the associated bore, an integral seal, e.g. a double ringed o-ring (seal), may be formed by the elastomeric overmold.

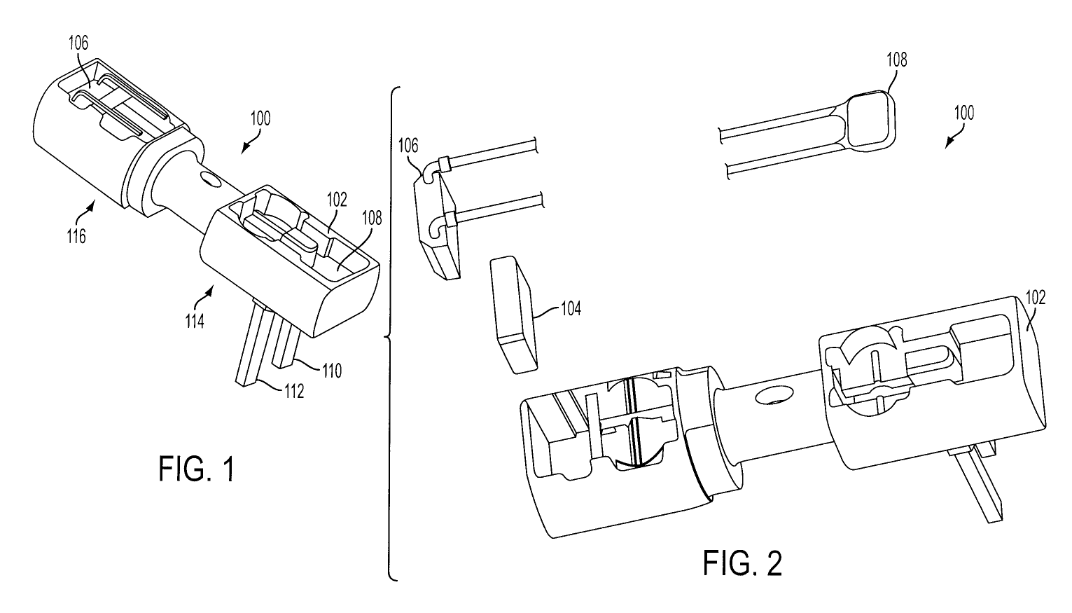

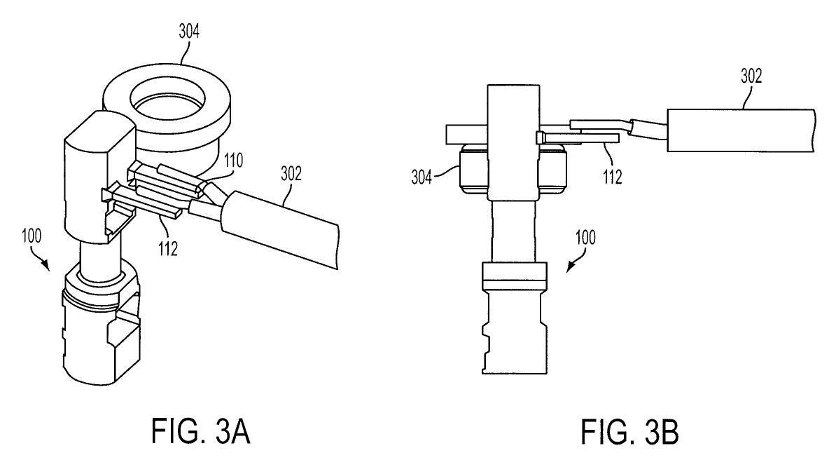

Referring to the drawings, FIG. 1 depicts and one exemplary embodiment of a speed sensor carrier assembly portion 100 of a sealed sensor assembly consistent with the present disclosure. As shown also in the exploded view of FIG. 2, the carrier assembly may include a carrier housing for at least partially enclosing a magnet 104, a Hall Effect device 106, and a capacitor 108. The carrier housing may be molded from a thermoplastic, such as polybutylene terephthalate (PBT) available from GE Plastics under the trade name VALOX. A pair of conductive leads 110, 112 may be provided for electrically connecting the Hall Effect device and capacitor 108 to an associated cable 302, as shown in FIGS. 3A and 3B.

To seal the carrier assembly portion 100 and the connection of the cable 302 thereto, the cabled carrier assembly portion may be inserted into an overmold as shown in FIGS. 3A and 3B, e.g. along with an associated bushing 304 for providing a mounting location for the assembly. In a first stage overmold, all or a portion of the cabled carrier assembly and bushing, may be overmolded with a thermoplastic overmold 400 that adheres to the PBT carrier housing and the bushing to seal at least a portion of the cabled carrier assembly and bushing from contaminants.

In the illustrated exemplary embodiment, the first stage overmold 400 covers and seals the electrical connection between the cable 302 and the leads 110, 112 and a top portion 114 of the carrier assembly 100 intended to be positioned at the exterior of an associated bore. In addition to sealing the electrical connection the overmold 400 may provide strain relief for connection between the cable 302 and the leads 110,112. The overmold 400 may also cover the bushing 304 and couple the bushing to the cabled carrier assembly, as shown. Those of ordinary skill in the art will, however, recognize that the overmold 400 may be provided in any configuration to cover and seal all or any part of the carrier assembly 100, the cable 302 and/or the bushing 304.

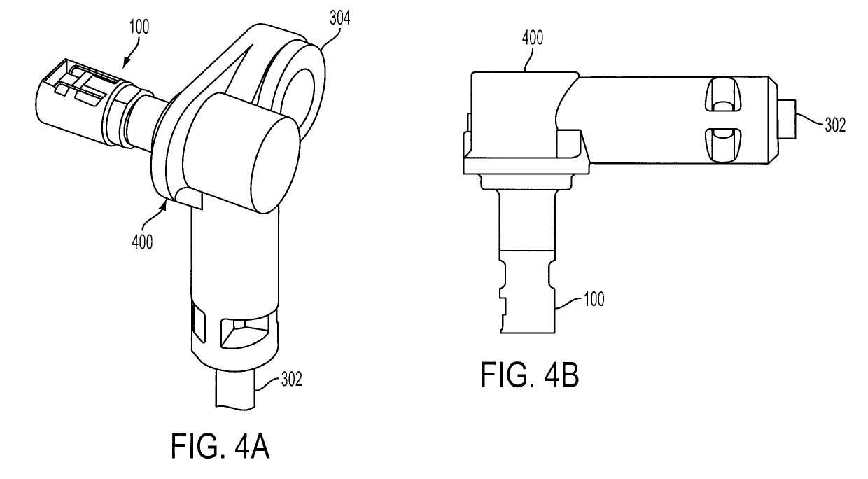

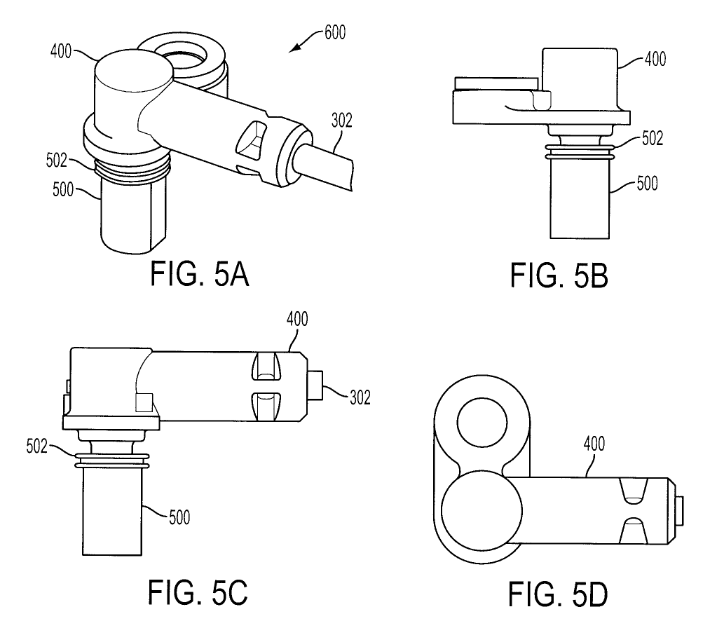

In an embodiment wherein only a portion of the carrier assembly 100 is overmolded in a first stage, as shown for example in FIGS. 4A and 4B, a second stage overmold 500 may be provided as shown in FIGS. 5A-5D. The second stage overmold 500 may be formed using thermoplastic that adheres to the PBT carrier housing to cover and seal a bottom portion 116 of the carrier assembly intended to be positioned at on the interior of an associated bore. The second stage overmold 500 may be provided with an integral seal 502 for sealing against intrusion into the associated bore, e.g. at the interface of the assembly and the bore opening. In the illustrated exemplary embodiment the integral seal is configured as a double ringed o-ring seal formed in the elastomeric overmold 500. Other configurations for the integral seal 502 may be provided.

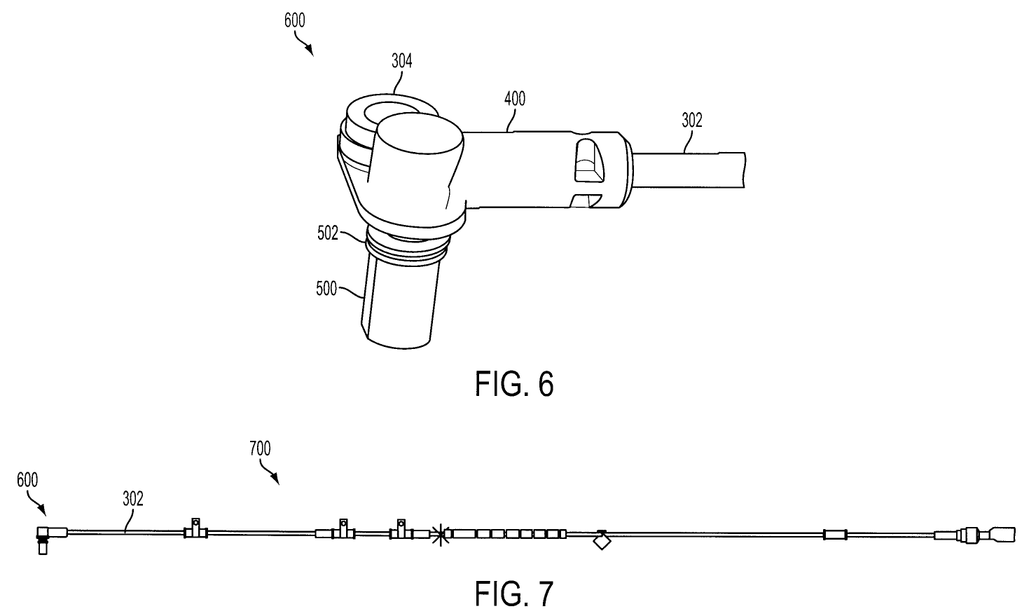

FIG. 6 illustrates one exemplary embodiment of a sealed sensor assembly 600 consistent with the present disclosure. FIG. 7 illustrates one exemplary embodiment of a cable assembly 700 incorporating a sealed sensor assembly 600 consistent with the present disclosure.

According to one aspect of the present disclosure, there is provided a sealed sensor assembly including an overmolded for sealing the assembly from contaminants. The overmold may be provided in a first stage for sealing portions of the assembly intended to be exterior to an associated bore, and in a second stage for sealing portions of the assembly intended to be disposed in an associated bore. An integral seal may be provided in the overmold to seal the interface between sensor and the associated bore. In one embodiment the integral seal may be configured as double o-ring seal.

According to another aspect of the present disclosure, there is provided a method of sealing a sensor assembly from contaminants including inserting the assembly into an overmold, providing a first stage overmold to cover a first portion of said sensor assembly intended to be external to an associated bore, and providing a second stage overmold to cover a second portion of the assembly intended to be disposed in the associated bore. At least one of the first and second stage overmolds may include an integral seal for sealing the interface between the sensor assembly and the associated bore from contaminants.

The features and aspects described with reference to particular embodiments disclosed herein are susceptible to combination and/or application in various other embodiments described herein. Such combinations and/or applications of such described features and aspects to such other embodiments are contemplated herein. Additionally, the embodiments disclosed herein are susceptible to numerous variations and modifications without materially departing from the spirit of the disclosed subject matter. Accordingly, the disclosure herein should not be considered to be limited to the particular embodiments disclosed herein.

What is claimed is:

1. A method of sealing a sensor assembly from contaminants, said method comprising:
inserting the sensor assembly into an overmold;
providing a first stage overmold to cover a first portion of said sensor assembly intended to be external to an associated bore; and
providing a second stage overmold to cover a second portion of the assembly intended to be disposed in the associated bore.

2. A method according to claim 1, wherein at least one of the first and second stage overmolds comprises an integral seal for sealing an interface between the sensor assembly and said associated bore from contaminants.
